(19) United States
(12) Patent Application Publication
(10) Pub. No.: US 2006/0262106 A1
(43) Pub. Date: Nov. 23, 2006

(54) PEN INPUT DEVICE WITH DATA STORAGE

(75) Inventor: Ko Jin SUK, Seongnam-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/383,007

(22) Filed: May 12, 2006

(30) Foreign Application Priority Data
Jan. 12, 2006 (KR) 10-2006-0003581
May 20, 2005 (KR) 10-2005-0042252

(51) Int. Cl. G09G 5/00

(52) U.S. Cl. 345/179

(57) ABSTRACT

A pen input device includes a data storage device and a transmitting and receiving unit. The transmitting and receiving unit is configured for receiving data from a host system, and for writing and reading data to and from the data storage device. The host system can include a tablet system, which also includes the pen input device that stores data, and transmits data to and from the tablet system.

### BACKGROUND

This description relates to pen input devices.

An electronic tablet is an input device generally used for two dimensional graphic processing. The tablet indicates coordinates for writing characters or drawing a picture using a pointing device, and detects the coordinates indicated through a plate-shaped tablet pad. A personal computer (PC) having a tablet function is typically referred to as a tablet PC, and a tablet pen is a pointing device used as an input device, in a manner similar to a mouse, for the tablet PC. A digitizer, which operates using radio frequencies, supports the use of the tablet pen in a tablet PC.

An electromagnetic tablet pen system can be used for operating a tablet pen in conjunction with a tablet PC. In this type of system, a sensor attached to a bottom of a liquid crystal display (LCD) is in communication with the tablet pen. The tablet pen includes an integrated circuit (IC) which communicates with the sensor. The sensor is connected to the system through a serial interface or a universal serial bus (USB) by a control IC, and the system includes a program for controlling the operation of the tablet pen. In this way, the tablet pen functions as an input device.

### SUMMARY

In one general aspect, a pen input device includes a pen-shaped body, a data storage device within the body, and a transmitting and receiving unit within the body and configured for receiving data from a host system. The transmitting and receiving unit is also configured for writing and reading data to and from the data storage device.

Implementations may include one or more of the following features. For example, the transmitting and receiving unit may be configured for providing RF-based communication with the host system. To this end, the transmitting and receiving unit may include an AD converter for RF-based data reception from the host system and a D/A converter for RF-based data transmission to the host system.

The pen input device may include a power supply unit configured for converting a RF-based AC signal supplied from the host system into a DC signal, and for supplying the converted DC signal to the data storage device.

The data storage device may include identification (ID) information for the pen input device.

The pen input device may include a sensor configured for detecting if the data storage device is capable of transferring data to or from the host system.

The pen input device may include a power supply unit for generating a voltage using a RF signal provided from the host system, which may be a tablet system.

The transmitting and receiving unit may include a RF data transmitter and receiver for transmitting and receiving data to and from the host system.

In another general aspect, a tablet system includes a tablet device and a pen input device. The pen input device includes a data storage device and a transmitting and receiving unit that is configured to receive data from the tablet device and to write and read data to and from the data storage device.

Implementations may include one or more of the following features and one or more of the features noted above. For example, the tablet device may be a tablet PC.

In another general aspect, controlling data storage in a pen input device and a host system includes determining an operation mode of the pen input device, and transmitting data between a host system and a data storage device within a pen input device based upon the operation mode.

Implementations may include one or more of the following features and one or more of the features noted above. For example, a determination may be made as to whether the pen input device is operatively communicating with the host system.

During a download mode, data may be stored within the data storage device of the pen input device. During an upload mode, data may be transmitted between the host system and the data storage device. The stored data may be retrieved from the data storage device and transmitted to the host system.

The transmission of data between the host system, which may be a tablet PC, and the data storage device may include transmitting a RF signal based on the operation mode.

The RF signal may be converted into a DC signal that is supplied to the data storage device.

A device driver for the data storage device may be loaded in the host system.

Identification information may be stored in the pen input device and read, for example, by the host system. Data transfer between the pen input device and the host system may be enabled or prevented based upon the identification information stored in the pen input device.

Other features and advantages will be apparent from the following description, including the drawings, and the claims.

### BRIEF DESCRIPTION OF THE DRAWINGS

FIG. 1 is a block diagram of an active type tablet pen system.

FIG. 2 is a block diagram of a passive type tablet pen system.

FIG. 3 is a schematic view of the system of FIG. 2.

FIG. 4 is a flowchart of a process for operating a passive type tablet pen.

FIG. 5 is a perspective view of a pen input device and a tablet PC.

FIG. 6 is a schematic view of a data format for an interface between the pen input device and a tablet PC.

FIG. 7 is a block diagram of a tablet pen storage device.

FIG. 8 is a flowchart of a process for transmitting and storing data in a tablet pen.

### DETAILED DESCRIPTION

In general, the same reference numbers will be used throughout the drawings to refer to the same or like parts.

In an exemplary process and system, a tablet pen is provided with bi-directional and wireless communication capability between the pan and a tablet PC. In addition, the tablet pen also includes a data storage component that permits data to be stored within the tablet pen.

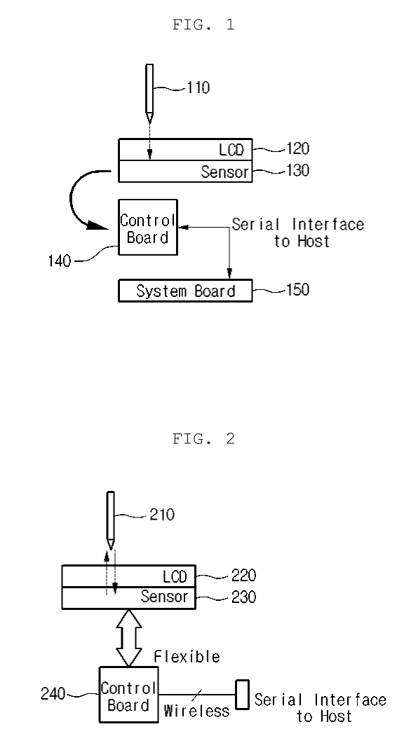

In general, a tablet pen may be an active type or a passive type of tablet pen. Referring to FIG. 1, an exemplary tablet pen system includes an active type tablet pen 110, a sensor 130 under a LCD 120, a control board 140 connected with the sensor 130 for determining the relative position and motion of the tablet pen 110, and a system board 150 which processes signals indicative of the relative motion of the tablet pen 110 received from the control board 140 through a serial interface. The system board 150 uses an application program to process the relative motion of the tablet pen 110. The active type of tablet pen 110 may include a battery, such that the tablet pen 110 can independently produce an electromagnetic field. The tablet pen 110 is a frequency source, and the sensor 130 is responsive to the electromagnetic field from the pen 110.

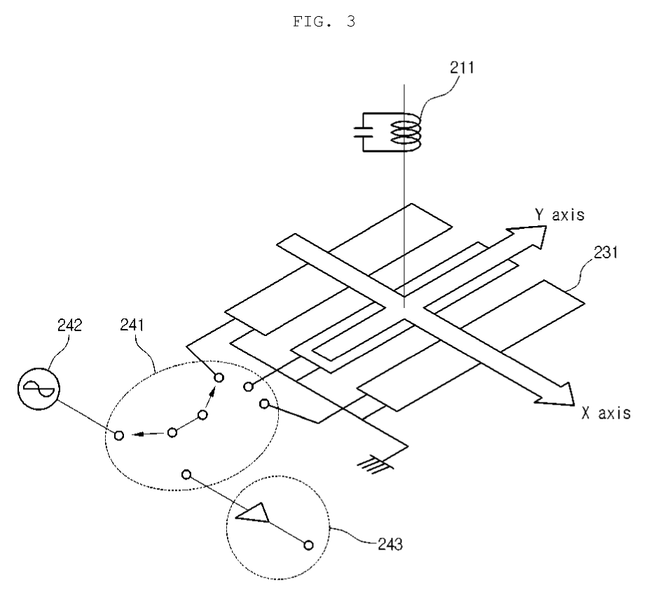

Referring to FIG. 2, an exemplary tablet pen system includes a passive type tablet pen 210 connected to a sensor 230 and a control board 240 that are both disposed beneath a LCD 220. The control board 240 communicates wirelessly with a host system using radio waves. In the passive type of tablet pen 210, the frequency source is the control board 240 that is connected with the sensor 230, and the tablet pen 210 is not provided with a battery. In addition, the tablet pen 210 and the control board 240 can bi-directionally communicate with each other.

The passive type of tablet pen 210 is typically an electromagnetic resonance type pen. The passive type of tablet pen system includes a digitizer having the sensor 230 and the control board 240 is magnetically coupled with the tablet pen 210 for purposes of powering the tablet pen 210.

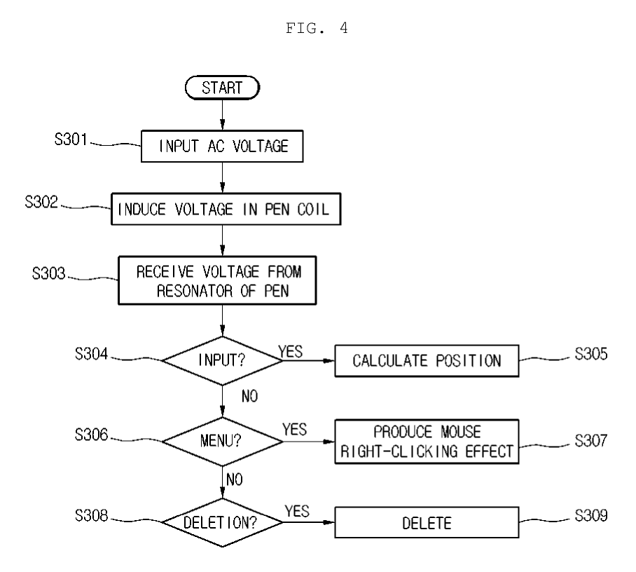

Referring to FIG. 3, the tablet pen 210 includes a pen coil 211, and the sensor 230 includes at least one sensor coil 231 to induce a voltage in pen coil 211. Sensor coils 231 are provided to control one or more operations of the tablet pen 210, including, for example, providing selection, deletion, and menu open functions for a user. The sensor coils 231 are connected to the control board 240 through a switch 241, such that the control board 240 can select the respective sensor coils 231 based on the selected operation of the user. The switch 241 provides a switching function to separate the operations of the sensor coils 231, and another switching function for frequency transmission and reception to and from the tablet pen 210. The control board 240 includes a frequency source 242 to induce a voltage in the tablet pen 210 and a receiver 243 to receive data.

Referring to FIG. 4, when an AC current is supplied to the sensor coil 231 of the sensor 230 (S301), a voltage is induced in the pen coil 211 (S302). A capacitor is connected to the pen coil 211 to form an LC resonator and to induce the voltage in the pen coil 211. Accordingly, if the AC current is cut off from the sensor 230, the sensor 230 receives the voltage generated by the pen coil 211 (S303). If the AC current is supplied to the sensor coil 231, the sensor coil 231 is a primary coil and the pen coil 211 is a secondary coil. If the AC current is cut off from the sensor coil 231, the pen coil 211 is a primary coil and the sensor coil is a secondary coil.

The control board 240 detects positions and operations of the tablet pen 210 according to the various operational modes. The operational modes may be distinguished, for example, based on the frequency received from the tablet pen 210. The frequency can be varied by changing the LC value of the LC resonator of the tablet pen 210. For example, if the detected frequency is 562.5 KHz, the control board 240 determines that the tablet pen 210 performs an input operation (S304) and calculates the position of the tablet pen 210 to send the calculated result to the system (S305). If the detected frequency is 531.25 KHz, the control board 240 determines that a menu key formed on a side of the tablet pen 210 is pressed (S306), and the same effect as that produced by the right-clicking of the mouse is derived (S307). If the detected frequency is 593.75 KHz, the control board 240 determines that the tablet pen 210 performs a data deletion operation (S308), and a selected item is deleted (S309).

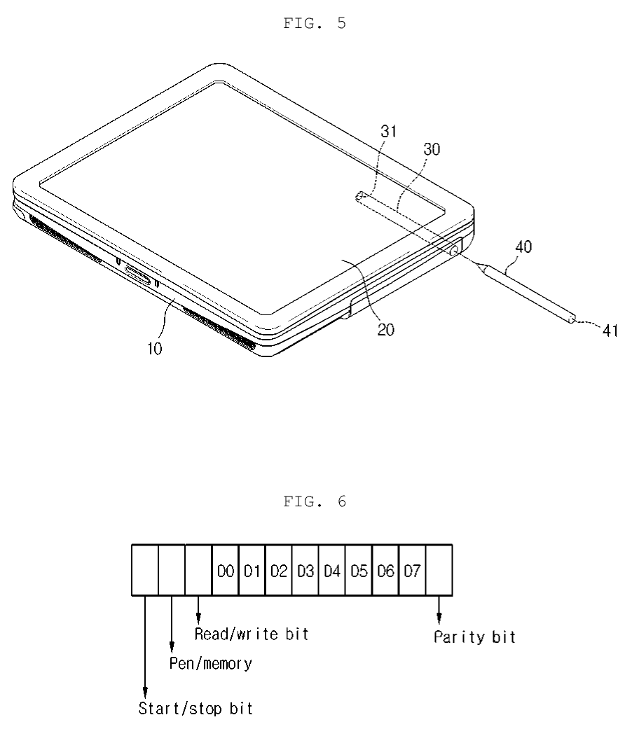

Referring to FIG. 5, in another implementation, a tablet PC 10 includes a liquid crystal display (LCD) and a sensor 20. The tablet PC 10 has a pen receiving part 30 formed in the tablet PC 10. The pen receiving part 30 is sized and shaped to receive and store a tablet pen 40 therein. The pen receiving part 30 also includes a detection switch 31 for detecting whether the pen 40 is mounted therein. Although the pen 40 can be configured as an active or passive type pen, the pen 40 shown in FIG. 5 is a passive type pen. The pen 40 may also include a USB port 41 that serves as a secondary interface unit for data transmission and reception.

If the pen 40 is mounted in the pen receiving part 30, the detection switch 31 detects the presence of the pen 40. This may be accomplished, for example, by providing a detection circuit that is completed when the pen 40 is properly positioned within the detection pen receiving part 30. If the pen 40 is detected, the tablet PC 10 recognizes the pen 40 as an external storage device capable of supporting data download or upload. For example, data can be downloaded from the tablet PC 10 to the built-in data storage component (e.g., a persistent or non-persistent memory device within the pen 40) of the pen 40, and/or data can be uploaded from the built-in data storage component to the tablet PC 10. Since the pen 40 is used as a data storage device, data transmitted between the pen 40 and the tablet PC 40 uses a predetermined format.

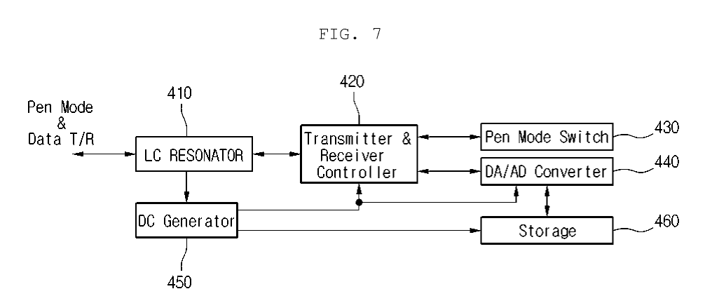

Referring to FIG. 6, an exemplary data format for use between the pen input device and the tablet PC includes a header part, a data part, and an error detection part. The header part includes a start and stop bit, a pen and memory bit, and a read and write bit. The data part includes eight data bits, e.g., D0 to D7. An error detection part includes a parity bit provided at an end of the data stream for use in error detection. The start and stop bit indicates a start or stop of a data set. The pen and memory bit indicates if a current operation mode is set as a pen mode or a memory mode. The memory mode is a mode in which the pen 40 is used as the data storage device, and the pen mode is a mode in which the pen 40 is used as a data input device with the tablet PC 10. The read and write bit indicates whether to write data from the tablet PC 10 to the built-in storage component of the pen 40 or to read data from the built-in storage of the pen 40 to the tablet PC 10.

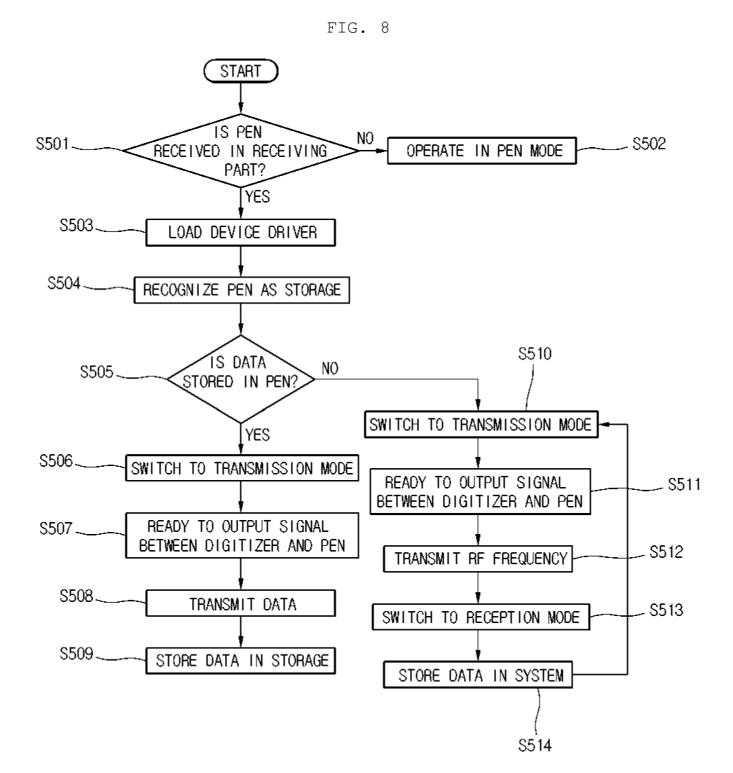

Referring to FIG. 7, the tablet pen data storage component provides data input and storage capability. The data storage component includes a LC resonator 410 for supplying a voltage through LC resonance, a transmitter and receiver controller 420 for controlling data transmission and reception to and from a system, such as a transceiver, and a pen mode switch 430 for providing a switching function for frequency conversion so as to execute a select/delete/menu function that is a general function of the tablet pen. The data storage component includes a DA/AD converter 440 for converting a RF signal transmitted or received between the tablet pen and the system into a digital signal, or converting the stored data into an analog signal so as to transmit it to the tablet PC. The data storage component includes a DC generator 450 for converting the AC voltage generated by the LC resonator 410 into DC voltage, and for supplying the DC voltage to the tablet pen. A data storage or memory device 460, e.g., persistent or non-persistent memory device, is provided for storing data transmitted or received between the tablet PC and the pen under control of the transmitter and receiver controller 420.

Referring to FIG. 5, the tablet pen 40 can transmit or receive data only when the pen is received in the receiving part 30. In addition, the detection switch is provided in the receiving part and detects whether the tablet pen 40 is received in the receiving part 30. A sensor may also be provided in the pen 40 for detecting if the pen 40 is received in the receiving part 30. The tablet pen 40 is a passive type pen that can transmit and receive data to and from the system with RF signals. In order to prevent a conflict with the operation of the pen during a general operating mode, the storage mode uses a frequency outside of the operating range of pen mode, e.g., 500-600 KHz, or uses a frequency that does not overlap with a frequency of the pen mode. Although the transmission rates are typically faster at higher frequencies, the designation of the appropriate frequency is influenced by other factors. For example, since a passive type tablet pen is not supplied with power through a separate battery, an appropriate frequency has to be selected that permits the supply of voltage imparted through resonance with the tablet PC.

The general mode function supports select, delete, and/or menu select functions that are designated through the LC resonator 410 and the pen mode switch 430. The tablet pen communicates with the system at a frequency that corresponds to the selected function and uses the voltage generated from the LC resonator 410.

The tablet pen 40 is used as storage device while it is not received in the receiving part 30. The transmitter and receiver controller 420 includes instructions for controlling the uploading of data to the system (the tablet PC) or the downloading of data from the system (the tablet PC) to the tablet pen 40. The transmitted and received data can be stored in the storage device 460 or can be transmitted from the storage device 460.

Referring to FIG. 8, a data write and read method using a tablet pen will be described below in greater detail. In operation S501, the PC tablet determines if the pen 40 is received in the receiving part 30 (S501). If the tablet pen 40 is not received, the tablet pen 40 continues to operate in the general pen mode (S502), e.g., in the pen mode. The operation of the pen 40 in the pen mode is typical of the operation of a variety of existing pen input devices, and is therefore not included in the following description. The tablet pen 40 can include a sensor that can detect if the tablet pen is received within the receiving part 30, or the receiving part 30 can include a sensor that detects presence of the tablet pen 40 within the receiving part 30.

If the tablet pen 40 is received in the receiving part 30, the pen 40 operates as a data storage device. In operation S503, a device driver is loaded and stored in the system which permits the system to recognize and communicate with the tablet pen 40. In operation S504, the tablet pen 40 is recognized as the storage device, and the device driver is stored in the system. The device driver is executed when the tablet pen 40 is received in the receiving part 30.

The tablet pen 40 can include a variety of data security features, e.g., including assigning a unique serial number as a kind of ID information for the pen 40 and/or user. The ID information is stored in the tablet pen 40, e.g., in storage device 460, and the stored unique serial number information (or other ID information that can substitute for a serial number) is loaded at the same time when the pen 40 is received in the receiving part 30. If the unique serial number information coincides with a serial number registered in the system, data transmission and/or reception to and from the system is enabled.

The system, e.g., the tablet PC 10, can transmit and receive data to and from the tablet pen 40 over RF signals and can convert the data into digital signals. After the system recognizes the tablet pen 40 as a storage device, the user can selectively determine whether to upload the data to the system or download the data from the system (S505), e.g., through a user interface on a display or a switch that provides control over the operating mode of the pen 40.

If download from the system to the tablet pen 40 is selected, the tablet pen 40 switches to a data transmission mode (S506) and is ready to receive the data from a digitizer of the system (S507). If the tablet pen 40 is completely ready to receive the data, it informs the system of the ready state and the system transmits the data to the tablet pen 40 (S508). For example, the tablet PC converts the data into a RF signal(s) and transmits the converted RF signals to the tablet pen 40. The tablet pen 40 receives the RF signal through the transmitter/receiver controller 420. The received RF signal is converted into digital data by the DA/AD converter 440, and the converted digital data is stored in the storage 460 (S509).

When the data stored in the storage device 460 of the tablet pen 40 is uploaded to the system, the tablet pen 40 switches to the transmission mode that allows the digitizer of the system to receive the data (S510). In operation S511, the transmission and reception of data between the digitizer and the tablet pen 40 is ready, e.g., since the tablet pen 40 is a passive type, the pen 40 requires adequate voltage in order to be ready to transmit data. When the digitizer drives a frequency source to generate a power signal, the LC resonator 410 of the tablet pen 40 receiving the generated signal generates an AC signal for supplying power to the pen 40. The DC generator 450 converts the AC signal generated by the LC resonator 410 into a DC signal, whereby a necessary voltage is supplied to permit data transfer. The DA/AD converter 440 of the tablet pen 40 converts the data stored in the storage device 460 into an analog signal, and converts the analog signal into a basic frequency RF signal. In operation S512, the DA/AD converter 440 also transmits the basic frequency RF signal. In operation S513, the digitizer switches to the reception mode to receive the RF signal from the tablet pen 40. In S514, the digitizer converts the received RF signal into digital data and stores the converted digital data in the system.

It will be apparent that various modifications and variations can be made to the aforementioned implementations. For example, the data can be stored in the added storage through the wireless transmission and reception to and from the system by using bi-directional wireless communication of the tablet pen operated passively or actively. The tablet pen can include a wired connection to a host system, e.g., a USB connection, and/or wireless communication with the host system.

In the aforementioned implementations, the tablet pen 40 is the passive type and therefore has no separate power supply. However, the tablet pen 40 can be provided with an independent power supply, e.g., an internal battery or through a wired connection, such as through a USB connection. In the passive type of pen 40, the supply voltage is provided by the LC resonator 410 is limited, and therefore, the size of the date that can be transmitted is also limited. Accordingly, in order to upload a large quantity of data to the system, the data of the storage device 460 is divided into a predetermined size and then the divided data is uploaded by repeating operations S410 to S415.

What is claimed is:

1. A pen input device comprising:
a pen-shaped body;
a data storage device within the body; and
a transmitting and receiving unit within the body and configured for receiving data from a host system, and for writing and reading data to and from the data storage device.

2. The pen input device according to claim 1, wherein the transmitting and receiving unit is configured for providing RF-based communication with the host system.

3. The pen input device according to claim 1, wherein the transmitting and receiving unit includes an AD converter for RF-based data reception from the host system and a D/A converter for RF-based data transmission to the host system.

4. The pen input device according to claim 1, further comprising a power supply unit configured for converting a RF-based AC signal supplied from the host system into a DC signal, and for supplying the converted DC signal to the data storage device.

5. The pen input device according to claim 1, wherein the data storage device includes identification (ID) information for the pen input device.

6. The pen input device according to claim 1, further comprising a sensor configured for detecting if the data storage device is capable of transferring data to or from the host system.

7. The pen input device according to claim 1, further comprising a power supply unit for generating a voltage using a RF signal provided from the host system, wherein the host system is a tablet system.

8. The pen input device according to claim 1, wherein the transmitting and receiving unit includes a RF data transmitter and receiver for transmitting and receiving data to and from the host system.

9. A tablet system comprising:
a tablet device;
a pen input device including
a data storage device, and
a transmitting and receiving unit configured for receiving data from the tablet device, and for writing and reading data to and from the data storage device.

10. The tablet system according to claim 10, wherein the tablet device is a tablet PC.

11. The tablet system according to 9, wherein the transmitting and receiving unit is configured for providing RF-based communication with the host system.

12. The tablet system according to claim 9, wherein the transmitting and receiving unit includes an AD converter for RF-based data reception from the host system and a D/A converter for RF-based data transmission to the host system.

13. The tablet system according to claim 9, further comprising a power supply unit configured for converting a RF-based AC signal supplied from the host system into a DC signal, and for supplying the converted DC signal to the data storage device.

14. The tablet system according to claim 9, wherein the data storage device includes identification (ID) information for the pen input device.

15. The tablet system according to claim 9, further comprising a sensor configured for detecting if the data storage device is capable of transferring data to or from the host system.

16. The tablet system according to claim 9, further comprising a power supply unit for generating a voltage using a RF signal provided from the host system, wherein the host system is a tablet system.

17. The tablet system according to claim 9, wherein the transmitting and receiving unit includes a RF data transmitter and receiver for transmitting and receiving data to and from the host system.

18. A method for controlling data storage in a pen input device and a host system, comprising:
determining an operation mode of the pen input device; and
transmitting data between a host system and a data storage device within a pen input device based upon the operation mode.

19. The method according to claim 18, further comprising determining if the pen input device is operatively communicated with the host system.

20. The method according to claim 18, further comprising storing the transmitted data within the data storage device of the pen input device, wherein the operation mode is a download mode.

21. The method according to claim 18, wherein transmitting data between the host system and the data storage device comprises retrieving stored data from the data storage device and transmitting the stored data to the host system, wherein the operation mode is an upload mode.

22. The method according to claim 18, wherein transmitting data between the host system and the data storage device comprises transmitting a RF signal based on the operation mode.

23. The method according to claim 18, wherein the host system is a tablet PC.

24. The method according to claim 18, further comprising providing a RF signal for supplying a voltage from the tablet system to the data storage device within the pen input device.

25. The method according to claim 24, further comprising:
converting the RF signal into a DC signal; and
supplying the DC signal to the data storage device.

26. The method according to claim 18, further comprising loading a device driver for the data storage device in the host system.

27. The method according to claim 18, further comprising:
storing identification information in the pen input device; and
reading the identification information stored in the pen input device.

28. The method according to claim 27, further comprising enabling data transfer between the pen input device and the host system based upon the identification information stored in the pen input device.

29. The method according to claim 27, further comprising preventing data transfer between the pen input device and the host system based upon the identification information stored in the pen input device.
